(19) United States
(12) Patent Application Publication
(10) Pub. No.: US 2018/0183215 A1
(43) Pub. Date: Jun. 28, 2018

(54) SPARK PLUG

(71) Applicant: IMAGINEERING, INC., Kobe (JP)

(72) Inventor: Yuji IKEDA, Kobe (JP)

(21) Appl. No.: 15/548,615

(22) PCT Filed: Feb. 4, 2016
(86) PCT No.: PCT/JP2016/053360

§ 371 Date: Mar. 8, 2018

(30) Foreign Application Priority Data
Feb. 4, 2015 (JP) 2015-020381

(51) Int. Cl. H01T 13/32; H05H 1/52

(52) U.S. Cl. CPC H01T 13/32; H05H 1/52

(57) ABSTRACT

A spark plug adopting an electromagnetic-wave-resonation-structure, efficiently ignites fuel inside a combustion chamber. The spark plug comprises a center electrode configured to transmit an electromagnetic wave having a discharge electrode, the discharge electrode mounted on a distal end of the center electrode, a casing member surrounding a periphery of the center electrode and the discharge electrode and a tip end part thereof functioning as a ground electrode so as to become in pair with the discharge electrode, and a vent configured to allow for an aerial passage is provided at a tip end of the casing member. At that time, the vent can be formed in a slit manner or in a hole type.

### TECHNICAL FIELD

The present invention relates to an ignition device, a spark plug used in an internal combustion engine such as a reciprocating engine and a rotary engine, specifically, a spark plug having an electromagnetic-wave-resonation-structure.

### BACKGROUND ART

Applicant has forwarded the development of art regarding the air-fuel ratio improvement by applying microwave technique to combustion in the internal combustion engine (for example, Patent Document 1). In Patent Document 1, the art is disclosed, which, after igniting fuel by using the spark plug, the ignited flame is enhanced and expanded by irradiating the microwave.

Moreover, the applicant developed the spark plug with use of the microwave resonation structure, which occurs discharge by boosting the inputted microwave (Patent Documents 2 & 3). With that ignition plug, the discharge in high speed can continuously be generated since the microwave is used as power source, and non local thermodynamic equilibrium plasma can be generated in arbitral timing. This cannot be achieved by the conventional spark plug, and the air-fuel ratio can be improved by using the new spark plug.

### PRIOR ART DOCUMENTS

### Patent Document(s)

Patent Document 1: Japanese Patent No. 4876217
Patent Document 2: Japanese unexamined patent application No. 2013-171781
Patent Document 3: Japanese unexamined patent application No. 2014-168540
Patent Document 4: Japanese unexamined patent application No. 2014-247500
Patent Document 5: U.S. Pat. No. 7,963,262

### SUMMARY OF INVENTION

### Problem to be Solved by Invention

However, there is a case where it is difficult to ignite efficiently fuel inside the combustion chamber with the above spark plug having microwave resonation structure, differentiating from the normal spark plug provided in manner that the discharge electrode and the ground electrode expose to the inside of the combustion chamber, since the discharge occurs between the discharge electrode and the cylindrical casing member surrounding the discharge electrode, and therefore, the discharge plasma concentrates not on the combustion chamber but on the plug-cylindrical-part.

The present invention is made from the above viewpoint.

### Means for Solving Problem

A spark plug used in an internal combustion engine comprises a center electrode configured to transmit an electromagnetic wave having a discharge electrode, the discharge electrode mounted on a distal end of the center electrode, and a casing member surrounding a periphery of the center electrode and the discharge electrode, a tip end part thereof functioning as a ground electrode so as to become in pair with the discharge electrode, and a vent configured to allow for an aerial passage is provided at a tip end of the casing member.

### Effect of Invention

According to the present invention, fuel inside a combustion chamber can efficiently be ignited in a spark plug that adopts an electromagnetic-wave-resonation-structure.

### BRIEF DESCRIPTION OF FIGURES

FIG. 1 is a front view of a partial cross-section that illustrates a structure of a spark plug 1.

FIG. 2 is an enlarged view of a distal end of the spark plug 1, (a) is a view seen from the distal end side thereof, and (b) is a front view of the partial cross section of the spark plug 1.

FIG. 3 is the enlarged view of the spark plug 1 regarding other example, (a) is a view seen from the distal end side thereof, and (b) is a front view of the partial cross section of the spark plug 1.

FIG. 4 is the enlarged view of the spark plug 1 regarding a second embodiment, (a) is a view seen from the distal end side thereof, (b) is an X-X line cross sectional view of partially notched of (a), and (c) is an X-X line cross sectional view of partially notched of (a) that differs in a flange part.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

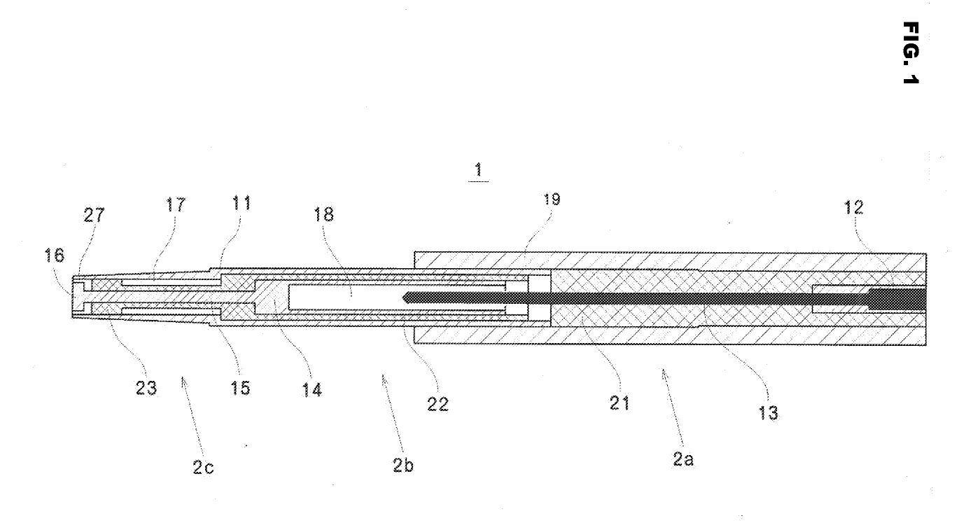

FIG. 1 shows a structure of a spark plug 1. The spark plug 1 functions as one kind of ignition device which is inserted into a mounting port of a cylinder head of an internal combustion engine such as gasoline engine and diesel engine, and then ignites fuel. The spark plug 1 is positioned at a center of the cylinder head as well as the normal spark plug. When the spark plug is used as an auxiliary aid for multi-point ignition for the purpose of the flame propagation distance, initial combustion time period saving, and main combustion time period saving, for example, referring to the one described in the Patent document 4 of the applicant, a plurality of spark plugs 1 may be provided in a peripheral part of the cylinder head such as a position between an exhaust port and an intake port, between the exhaust port and the exhaust port, and/or between the intake port and the intake port. Referring to FIG. 1, the spark plug 1 is largely divided into an input part 1a, a coupling part 1b, and a resonation part 1c. The input part 1a receives microwave from the outside circuit such as oscillator. An impedance matching between the outside circuit and the resonation part 1c is attained in the coupling part 1b, specifically, a capacity-coupling is performed so as to attain the impedance matching at a microwave frequency band region. The resonation part 1c is constituted of microwave resonation structure, and performs microwave boosting. A discharge electrode 16 is provided at a distal end of the resonation part 1c. The coupling part 1b and the resonation part 1c are housed inside a casing 11, and the input part 1a is housed inside a casing 19. The casing 11 also functions as a ground electrode, and the spark plug 1 is formed such that the discharge is performed at a gap 27 between the discharge electrode 16 and the casing 11 by boosted microwave in the resonation part 1c.

In the input part 1a, an input terminal 12 and a first center electrode 13 are provided, the input terminal 12 jointed with a coaxial cable configured to transmit the microwave generated at the outside oscillation circuit, and the first center electrode 13 configured to transmit the microwave received from the input terminal 12 to the distal end thereof. A dielectric 21 is provided between the first center electrode 13 and the casing 11.

In the coupling part 1b, the first center electrode 13 and a second center electrode 14 are provided. The second center electrode 14 has a cylindrical part 18 with a bottom at the resonation part 1c side, and the first center electrode 13 is inserted into the cylindrical part 18. That is, the stick-type first center electrode 13 and an inner wall of the cylindrical part of the second center electrode 14 face with each other, and the microwave is transmitted from the first center electrode 13 to the second center electrode 14 via capacity-coupling at the facing part. A dielectric 22 is provided between the second center electrode 14 and the casing 11. Suppose that an impedance of the outside circuit such as the coaxial cable is 50Ω and an impedance of the resonation part 1c is 10Ω, considering simply without taking into account of imaginary number component, an impedance of the coupling part 1b may just be set approximately at 20Ω. Moreover, from the viewpoint of the impedance matching and the resonation frequency adjustment and etc., a dielectric having a predetermined dielectric constant, composed of, for example, ceramic such as aluminum, steatite, silicon nitride, photoveel, fluorocarbon polymers, can be arranged as a cylindrical member that is insert-able into the space 18.

Here, the impedance of the coupling part 1b is determined by such as (1) positional relation between the inner wall of the cylindrical part of the second center electrode 14 and the first center electrode 13 inserted into the cylindrical part, i.e., distance and the facing area therebetween, (2) positional relation between the second center electrode 14 and the casing 11, i.e., distance and the facing area therebetween, and (3) material of the dielectric 23 filled between the second center electrode 14 and the casing 11.

A third center electrode 15 is provided in the resonation part 1c. Moreover, a cylindrical dielectric 23 is arranged around the distal end side of the third center electrode 15. On the other hand, only a circular annular space is existed between the rear end side of the third center electrode 15 and the casing 11, and the dielectric 23, for example, is not provided therebetween. The third center electrode 15 is connected to the second center electrode 14, and the microwave is transmitted from the second center electrode 14 to the third center electrode 15, and further transmitted to the discharge electrode 16. The third center electrode 15 is designed so as to be about ¼ wavelength of microwave. Here, “¼ wavelength of microwave” means the length such that microwave propagating on the third center electrode 15 substantially becomes ¼ wavelength that takes into account of refractive index of the third center electrode 15 and refractive index of the dielectric 23 that is an adjusting member to the third center electrode 15, and the “¼ wavelength of microwave” does not certainly mean the ¼ length of value divided simply light velocity by frequency numerically. In other word, the length of the third center electrode 15 corresponds to the ¼ microwave wavelength when a node of microwave becomes positioned at the rear end side of the third center electrode 15, and corresponding to that, an anti-node of the microwave is positioned at the distal end side thereof. Repeatedly, if the design is performed such that the node of microwave is positioned at the rear end side of the third center electrode 15 and the anti-node of microwave is positioned at the distal end side thereof, a potential at the discharge electrode 16 that is arranged at the distal end of the third center electrode 15 can be increased or enlarged. Eventually, the discharge can occur at the gap 27 by generating a high voltage between the discharge electrode 16 and the casing 11.

In the resonation part 1c, a reactance element “L” is defined mainly by a coil element of the third center electrode 15, and a capacitance element “C” is defined mainly by a capacitance formed by the third center electrode 15, the discharge electrode 16, and the casing 11, more concretely, defined by such as (1) shape and size of the discharge electrode 16, and distance from/to the casing 11, (2) distance between the third center electrode 15 and the casing 11, and (3) length ratio of the space (air layer) 17 between the third center electrode 15 and the casing 11 with respect to the dielectric 24. The resonation part 1c is designed such that the virtual equivalent circuit prescribed by the “L” and “C” resonates at the frequency band area.

As described above, the spark plug 1, by the boost system of the resonator, generates voltage Vc3 higher than a power source voltage, voltage V1 of microwave inputted into the spark plug 1. Thereby, the discharge occurs between the discharge electrode 16 and the ground electrode (casing 11). If the discharge voltage exceeds over the breakdown voltage of gaseous molecule in the vicinity thereof, non local thermodynamic equilibrium plasma is generated by emission of electron from gaseous molecule, and the fuel is ignited.

The casing 11 and each of center electrodes 12,13, and 14 in the spark plug 1, can be composed of a conductive metal such as tungsten, molybdenum, brass, stainless (SUS), tantalum, and beryllium copper. All the members may adopt same material, for example, tungsten, or they may properly be used in different material based on usage way. In any case where what kind of material is used, it belongs to the scope of the present invention.

Moreover, the dielectric 21, 22, 23 can be composed of ceramic such as aluminum, steatite, and silicon nitride as the material.

As illustrated in FIG. 2, a slit 31 is formed at a tip end side of the casing 11. The slit 31 functions as a vent for allowing an aerial passage. The air flow (swirl flow) in the combustion chamber passes through the slit 31, then enters into the gap 27, and passes through the distal end side of the gap 27 towards the combustion chamber side. Thereby, plenty of oxygen can be supplied to the discharger, and therefore, the discharge easily occurs between the casing 11 and the third center electrode 15, and as a result, the combustion performance is enhanced. Moreover, the air flow directing from the spark plug 1 towards the inside of the combustion chamber appears, and thereby, the discharge plasma can be prevented from staying at the gap 27 between the discharge electrode 16 and the cylindrical casing 11, and the discharge plasma can be supplied to the combustion chamber side. Thereby, the ignition performance inside the combustion chamber can also be enhanced.

Moreover, the spark plug 1 can be used in rotary engine. As well as the swirl flow of the reciprocating engine, the ignition performance can be enhanced in the rotary engine when the aerial flow appearing in rotation direction by the rotor rotation is introduced from the vent. Moreover, in a case of rotary engine, it is difficult to arrange in a protrusion manner of spark plug towards the combustion chamber, differentiating from the reciprocating engine. Then, it is disadvantageous in a point of efficiently supplying the discharge plasma into the combustion chamber, but that problem can be solved by adopting and providing the slit as above and generating air flow directing from the spark plug 1 towards center direction (inside) of the combustion chamber.

Moreover, an electrical property of the spark plug 1, i.e., Q factor, can be enhanced by providing a slit. Generally, Q factor of resonator is defined by square root of L/C. Q factor can be enhanced since the providing of the slit leads to the capacitance C reduction because the providing of the slit means the reduction of the capacitor-electrode-area at the ground electrode side.

The spark plug 1 is advantageous in size-reduction since the spark plug 1 uses the frequency at 2.45 GHz band, and therefore, small size of the capacitor is sufficient. Moreover, an isolation performance is excellent, since only the vicinity of the discharge electrode 16 of the spark plug 1 becomes high in voltage by adopting the boost system. In these points, the ignition device of the present invention is superior to the conventional ignition device having the resonation structure, for example, Patent Document 5.

The discharge of the spark plug 1 is also performed at a microwave (GHz) cycle period, since the spark plug 1 is driven by microwave. Therefore, generated OH radicals and etc. are maintained without extinction because next discharge is performed before extinction thereof. Compared to that, in the conventional spark plug, once generated radicals are soon going to extinguish since ON/OFF of spark cannot be controlled at the high frequency. Therefore, the above effects cannot be obtained by use of the conventional spark plug.

As above, an embodiment of the present invention is explained. The scope of the present invention is defined based on the attached claims, and should not be limited to the above embodiment.

For example, the present-invention-subjected ignition device is not limited to the above-mentioned spark plug 1, but other types may be adopted if the ignition device may be the one that adopts an electromagnetic-wave-resonation-structure. Moreover, although the spark plug 1 is driven by microwave, the electromagnetic wave having other band region may be used.

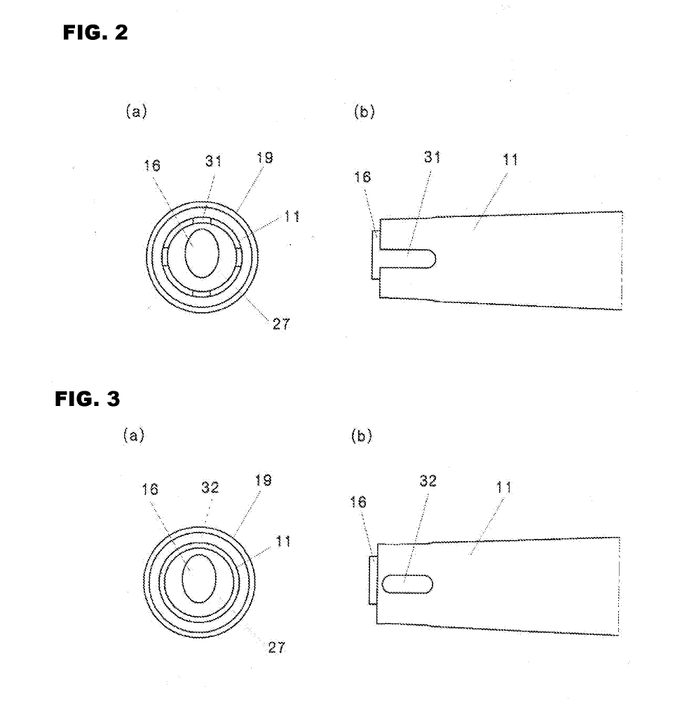

Moreover, as the vent, an air vent 32 illustrated in FIG. 3 may be adopted, replacing from the slit of FIG. 2.

Moreover, compared to the discharge electrode 16, the tip end side of the casing 11 may be configured to expose further towards the combustion chamber side. Thereby, the electric field can be concentrated on furthermore tip end side, and combined with the aerial effect at the vent, the plasma can be supplied more effectively to the inside of the combustion chamber.

### Second Embodiment

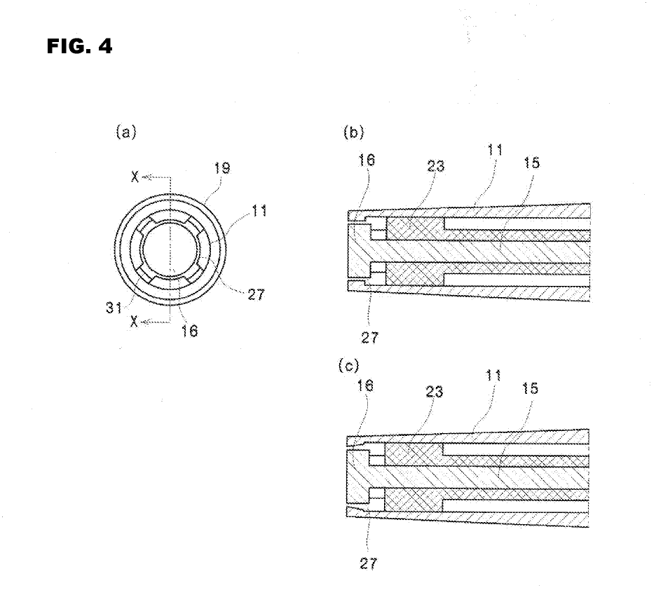

In FIG. 4, an ignition device 2 of the present invention is illustrated. The ignition device is similar to the first embodiment except for different shape of the discharge electrode 16 and the slit 31 that is formed at the tip end of the casing, ground electrode 11, and the explanation thereof is omitted.

The discharge electrode 16 of the spark plug 1 is made in a circular shape differentiating from the elliptical shape illustrated in the first embodiment, and aligned in the axis center to the tip end part in circle of the casing 11 functioning as the ground electrode. Thereby, the gap between the discharge electrode 16 and the casing 11 being the ground electrode becomes even. The discharge occurs at random at any point on circle that is not notched of the casing 11 being the ground electrode by setting a distance of the gap to the distance discharge-able properly. By being at random position of discharge, erosion and corrosion can effectively be prevented since the discharge point formed by the discharge electrode 16 and the distal end of the casing 11 is not concentrated at one point.

When the width of each slit 31 formed at the tip end part of the casing 11 being L, and the total thereof becoming ΣL (In Fig. there are four positions, i.e., 4L), and the circumference distance of the tip end part of the casing 11 is set to be M, the configuration is preferably made within the range between 0.2M≤ΣL≤0.7M, and more preferably, made within the range between 0.3M≤ΣL≤0.6M. According to experiment of the inventor of the present invention, fine plasma generation is confirmed when the diameter of the tip end part of the casing 11 is 4.5 mm, i.e., M=14 mm, the width of slit 31, L=1.2 mm˜2.0 mm (ΣL=4.8 mm˜8 mm), i.e., the range of ΣL=0.34M˜0.57M.

The tip end part of the casing 11 adjacent to the slit 31 functions as the ground electrode, on the other hand, becomes a factor of cooling loss of depriving plasma heat generated by the discharge. Therefore, it is preferable that the size of area where the ground electrode contacts to the plasma becomes smaller within the range of being capable of securing the size of the tip end being workable as the ground electrode. According to the experiment by the inventors, it turned out that the configuration of the width L of slit 31, total of the width L, i.e., ΣL to set within the range as above, is preferable for reduction of cooling loss.

Moreover, a flange part protruding into the inside is formed on the inner circumference surface of circular tip end of the casing 11 functioning as the ground electrode, as illustrated in FIG. 4(b). Thereby, the electric field concentrating spot (discharge point) can surely be located at the tip end side, not the inside gap 27 side. Moreover, as illustrated in FIG. 4(c), the flange part protruding into the inside can be made, seen from the axial direction, in taper manner that the shape expands and extends from inside to outside. Thereby, more tip end side can become the electric field concentrating spot.

### INDUSTRIAL APPLICABILITY

As illustrated above, according to a spark plug of the present invention, the breakdown (discharge) can occur only by an electromagnetic wave. Specifically, fuel inside the combustion chamber can effectively be ignited by providing a vent configured to allow for an aerial passage at the tip end of the casing part functioning as the ground electrode. As a result, the spark plug of the present invention can broadly be used as the internal combustion engine for vehicles, airplanes, and ships, for example.

### NUMERAL SYMBOLS EXPLANATION

1. Ignition Device
1a. Input Part
1b. Coupling Part
1c. Resonation Part
11. Casing (Ground Electrode)
12. Microwave Input Terminal
13. First Center Electrode
14. Second Center Electrode
15. Third Center Electrode
16. Discharge Electrode
17. Space
18. Space
19. Casing
21. Dielectric
22. Dielectric
23. Dielectric
27. Gap
31. Slit
32. Air Vent

1. A spark plug used in an internal combustion engine, comprising:
a center electrode configured to transmit an electromagnetic wave having a discharge electrode;
the discharge electrode mounted on a distal end of the center electrode; and
a casing member surrounding a periphery of the center electrode and the discharge electrode, and a tip end part thereof functioning as a ground electrode so as to become in pair with the discharge electrode, and
wherein a vent configured to allow for an aerial passage is provided at a tip end of the casing member.

2. The spark plug according to claim 1, wherein the vent is formed in a slit manner.

3. The spark plug according to claim 1, wherein the vent is formed in a hole type.

4. The spark plug according to claim 1,
wherein the tip end of the casing member is exposed towards a combustion chamber side of the internal combustion chamber further, compared to the discharge electrode.
